(19) United States
(12) Patent Application Publication
(10) Pub. No.: US 2015/0340747 A1
(43) Pub. Date: Nov. 26, 2015

(54) METAL-AIR BATTERY CELL, METAL-AIR BATTERY INCLUDING METAL-AIR BATTERY CELL AND METHOD OF FABRICATING THE SAME

(71) Applicant: Samsung Electronics Co., Ltd., Suwon-si (KR)

(72) Inventors: Hyukjae Kwon, Suwon-si (KR); Jeongsik Ko, Seongnam-si (KR); Sangbok Ma, Suwon-si (KR); Hyunchul Lee, Hwaseong-si (KR); Taeyoung Kim, Seoul (KR); Dongjoo Lee, Suwon-si (KR); Dongmin Im, Seoul (KR)

(21) Appl. No.: 14/721,067

(22) Filed: May 26, 2015

(30) Foreign Application Priority Data
May 26, 2014 (KR) 10-2014-0063110

(51) Int. Cl. H01M 12/02; H01M 12/08

(52) U.S. Cl. CPC H01M 12/02; H01M 12/08

(57) ABSTRACT

A metal-air battery cell includes: a negative electrode metal layer; a positive electrode layer configured to use oxygen as an active material for which a reduction/oxidation reaction of oxygen introduced thereto occurs; a negative electrode electrolyte film disposed between the negative electrode metal layer and the positive electrode layer in a thickness direction; and a channel layer disposed on the positive electrode layer and comprising a plurality of channel structures, the channel structures each elongated to extend in an extension direction crossing the thickness direction.

### CROSS-REFERENCE TO RELATED APPLICATIONS

This application claims priority to Korean Patent Application No. 10-2014-0063110, filed on May 26, 2014, and all the benefits accruing therefrom under 35 U.S.C. §119, the disclosure of which is incorporated herein in its entirety by reference.

### BACKGROUND

1. Field

Provided is a metal-air battery cell, a metal-air battery including the metal-air battery cell, and a method of fabricating the metal-air battery cell, and more particularly, a metal-air battery cell that is configured to easily supply air to a positive electrode and is improved in terms of energy density, a metal-air battery including the metal-air battery cell, and a method of fabricating the metal-air battery cell.

2. Description of the Related Art

Metal-air batteries each include a plurality of metal-air battery cells, and each metal-air battery cell includes a negative electrode capable of intercalating/deintercalating ions and a positive electrode using oxygen included in air as an active material. A reduction/oxidation reaction of introduced oxygen occurs at the positive electrode, and an oxidation/reduction reaction of metal occurs at the negative electrode. Electric energy is obtained from chemical energy generated by such reactions. For example, a metal-air battery absorbs oxygen when being electrically discharged and emits oxygen when being electrically charged. As described above, since metal-air batteries use oxygen included in air, the energy density of the metal-air batteries may be markedly increased. For example, the energy density of metal-air batteries may be several times the energy density of lithium ion batteries.

In addition, since there is a relatively low possibility of metal-air batteries catching on fire in abnormal high-temperature conditions, metal-air batteries may be stably used. Furthermore, since metal-air batteries are operated through absorption/release of oxygen without using a heavy metal material, metal-air batteries may cause relatively less environmental pollution compared to conventional batteries. Owing to the above-mentioned characteristics, much research into metal-air batteries has been conducted.

### SUMMARY

Provided are a metal-air battery cell that is configured to easily supply air to a positive electrode and is improved in terms of energy density, a metal-air battery including the metal-air battery cell, and a method of fabricating the metal-air battery cell.

Additional features will be set forth in part in the description which follows and, in part, will be apparent from the description, or may be learned by practice of the presented embodiments.

Provided is a metal-air battery cell including: a first negative electrode metal layer; a first positive electrode layer configured to use oxygen as an active material for which a reduction/oxidation reaction of oxygen introduced thereto occurs; a first negative electrode electrolyte film disposed between the first negative electrode metal layer and the first positive electrode layer in a thickness direction; and a first channel layer disposed on the first positive electrode layer and including a plurality of first channel structures, the first channel structures each elongated to extend in an extension direction crossing the thickness direction.

Each first channel structure among the plurality of first channel structures among the channel structures may be convex in a direction away from an upper surface of the positive electrode layer.

First cavities of the first channel layer may be defined by the upper surface of the first positive electrode layer and inner surfaces of the convex first channel structures, respectively.

The first cavities of the first channel layer may have a polygonal cross-sectional shape, a semicircular cross-sectional shape or a wave-form cross-sectional shape.

The metal-air battery cell may further include: a second negative electrode metal layer disposed under the first negative electrode metal layer; a second positive electrode layer disposed under the second negative electrode metal layer and configured to use oxygen as an active material for which a reduction/oxidation reaction of oxygen introduced thereto occurs; and a second negative electrode electrolyte film disposed between the second negative electrode metal layer and the second positive electrode layer in the thickness direction.

The first negative electrode metal layer, the first negative electrode electrolyte film and the first positive electrode layer may each be continuously extended and disposed at opposing sides of the first channel layer in the thickness direction.

The first negative electrode metal layer, the first negative electrode electrolyte film, the first positive electrode layer and the first channel layer may each be continuously extended and bent about an axis to define the metal-air battery cell in a roll form.

The first negative electrode metal layer, the first negative electrode electrolyte film and the first positive electrode layer may each be continuously extended and bent upward toward the first channel layer to define the metal-air battery cell in a flat form, and in the flat form of the metal-air battery cell, the first positive electrode layer may contact apexes of the convex first channel structures of the first channel layer.

An end of the channel layer in an extension direction of the channel structures may be exposed outside the metal-air battery cell.

The metal-air battery cell may further include: a sub positive electrode layer configured to use oxygen as an active material for which a reduction/oxidation reaction of oxygen introduced thereto occurs, disposed on a surface of the first channel structures of the first channel layer.

The negative electrode electrolyte film may include: a separator which is impermeable with respect to oxygen and conductive with respect to metal ions; and an electrolyte configured to conduct the metal ions.

The first channel structures of the first channel layer may have a porous structure.

Provided is a metal-air battery including a first metal-air battery cell and a second metal-air battery cell. Each of the first and second metal-air battery cells includes: a first negative electrode metal layer; a first positive electrode layer configured to use oxygen as an active material for which a reduction/oxidation reaction of oxygen introduced thereto occurs; a first negative electrode electrolyte film disposed between the first negative electrode metal layer and the first positive electrode layer in a thickness direction; and a first channel layer disposed on the first positive electrode layer and including a plurality of first channel structures, the first channel structures each elongated to extend in an extension direction crossing the thickness direction.

The first channel layer of the first metal-air battery cell may be disposed between the first negative electrode metal layers of the first and second metal-air battery cells in the thickness direction.

The metal-air battery may further include an oxygen blocking layer disposed between the first channel layer of the first metal-air battery cell and the first negative electrode metal layer of the second metal-air battery cell in the thickness direction.

Each of the first and second metal-air battery cells may further include: a second negative electrode metal layer disposed under the first negative electrode metal layer; a second positive electrode layer disposed under the second negative electrode metal layer and configured to use oxygen as an active material for which a reduction/oxidation reaction of oxygen introduced thereto occurs; and a second negative electrode electrolyte film disposed between the second negative electrode metal layer and the second positive electrode layer in the thickness direction.

For each of the first and second metal-air battery cells, the first negative electrode metal layer, the first negative electrode electrolyte film and the first positive electrode layer are each continuously extended and disposed at opposing sides of the first channel layer in the thickness direction.

Provided is a method of fabricating a metal-air battery cell, including: disposing a first negative electrode electrolyte film between a first negative electrode metal layer and a first positive electrode layer in a thickness direction, the first positive electrode layer configured to use oxygen as an active material for which a reduction/oxidation reaction of oxygen introduced thereto occurs; and disposing a first channel layer on the first positive electrode layer, the first channel layer including a plurality of first channel structures each elongated to extend in an extension direction crossing the thickness direction.

The method may further include: disposing a second negative electrode electrolyte film between a second negative electrode metal layer and a second positive electrode layer, the second positive electrode layer configured to use oxygen as an active material for which a reduction/oxidation reaction of oxygen introduced thereto occurs; and disposing the second negative electrode metal layer and the first negative electrode metal layer facing each other.

The first negative electrode metal layer, the first negative electrode electrolyte film and the first positive electrode layer may each be continuously extended and the method may further include bending the continuously extended first negative electrode metal layer, first negative electrode electrolyte film and first positive electrode layer to be disposed at opposing sides of the first channel layer in the thickness direction.

### BRIEF DESCRIPTION OF THE DRAWINGS

These and/or other features will become apparent and more readily appreciated from the following description of the embodiments, taken in conjunction with the accompanying drawings in which:

FIG. 1 is a perspective view schematically illustrating a metal-air battery cell according to an embodiment of the present invention;

FIG. 2 is an enlarged cross-sectional view illustrating portion A1 of the metal-air battery cell illustrated in FIG. 1;

FIGS. 3A to 3C are enlarged cross-sectional views illustrating modified examples of cavities of the metal-air battery cell illustrated in FIG. 2;

FIG. 4 is a cross-sectional view illustrating a metal-air battery cell in which sub positive electrode layers are disposed on a channel layer according to an embodiment of the present invention;

FIG. 5 is a cross-sectional view illustrating a metal-air battery cell according to another embodiment of the present invention;

FIG. 6 is a cross-sectional view illustrating a metal-air battery cell configured to prevent oxygen from making contact with a negative electrode metal layer according to another embodiment of the present invention;

FIGS. 7A_1 and 7B_1 are perspective views illustrating examples in which the metal-air battery cell illustrated in FIG. 1 is bent, and FIGS. 7A_2 and 7B_2 are enlarged cross-sectional views of the metal-air battery cells illustrated in FIGS. 7A_1 and 7B_1, respectively;

FIGS. 8A and 8B are perspective views illustrating other examples in which the metal-air battery cell illustrated in FIG. 1 is bent;

FIGS. 9, 10 and 11A are perspective views illustrating metal-air battery cells each including a negative electrode metal layer, a negative electrode electrolyte film and a positive electrode layer that are bent according to embodiments of the present invention, and FIG. 11B is a cross-sectional view of the metal-air battery cell illustrated in FIG. 11A taken along xlb-xlb;

FIG. 12 is a perspective view illustrating a metal-air battery including a plurality of metal-air battery cells such as the metal-air battery cell illustrated in FIG. 1, according to an embodiment of the present invention;

FIG. 13 is a perspective view illustrating a metal-air battery including a plurality of metal-air battery cells such as the metal-air battery cell illustrated in FIG. 5, according to an embodiment of the present invention;

FIG. 14 is a perspective view illustrating a metal-air battery including a plurality of metal-air battery cells such as the metal-air battery cell 30a illustrated in FIGS. 7A_1 and 7A_2, according to an embodiment of the present invention;

FIG. 15 is a perspective view illustrating a metal-air battery including a plurality of metal-air battery cells such as the metal-air battery cell illustrated in FIG. 9, according to an embodiment of the present invention;

FIG. 16 is a perspective view illustrating a metal-air battery including a plurality of metal-air battery cells such as the metal-air battery cell illustrated in FIG. 10, according to an embodiment of the present invention;

FIGS. 17A to 17C are schematic cross-sectional views illustrating a method of fabricating the metal-air battery cell illustrated in FIG. 1, according to an embodiment of the present invention;

FIGS. 18A to 18E are schematic cross-sectional views illustrating a method of fabricating the metal-air battery cell illustrated in FIG. 5, according to an embodiment of the present invention; and

FIGS. 19A and 19B are schematic cross-sectional views illustrating an exemplary process of deforming the metal-air battery cell illustrated in FIG. 17C, according to an embodiment of the present invention.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain features of the present description.

As used herein, the term “and/or” includes any and all combinations of one or more of the associated listed items. As used herein, the singular forms “a,” “an,” and “the” are intended to include the plural forms, including expressions such as “at least one of,” when preceding a list of elements, modify the entire list of elements and do not modify the individual elements of the list. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the drawings, like reference numbers refer to like elements, and also the size of each element may be exaggerated for clarity of illustration. The embodiments described herein are for illustrative purposes only, and various modifications may be made therefrom. In the following description, when an element is referred to as being “above” or “on” another element in a layered structure, it may be directly on the other element while making contact with the other element or may be above the other element without making contact with the other element.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a metal-air battery cell, a metal-air battery including the metal-air battery cell, and a method of fabricating the metal-air battery cell will be described in detail with reference to the accompanying drawings.

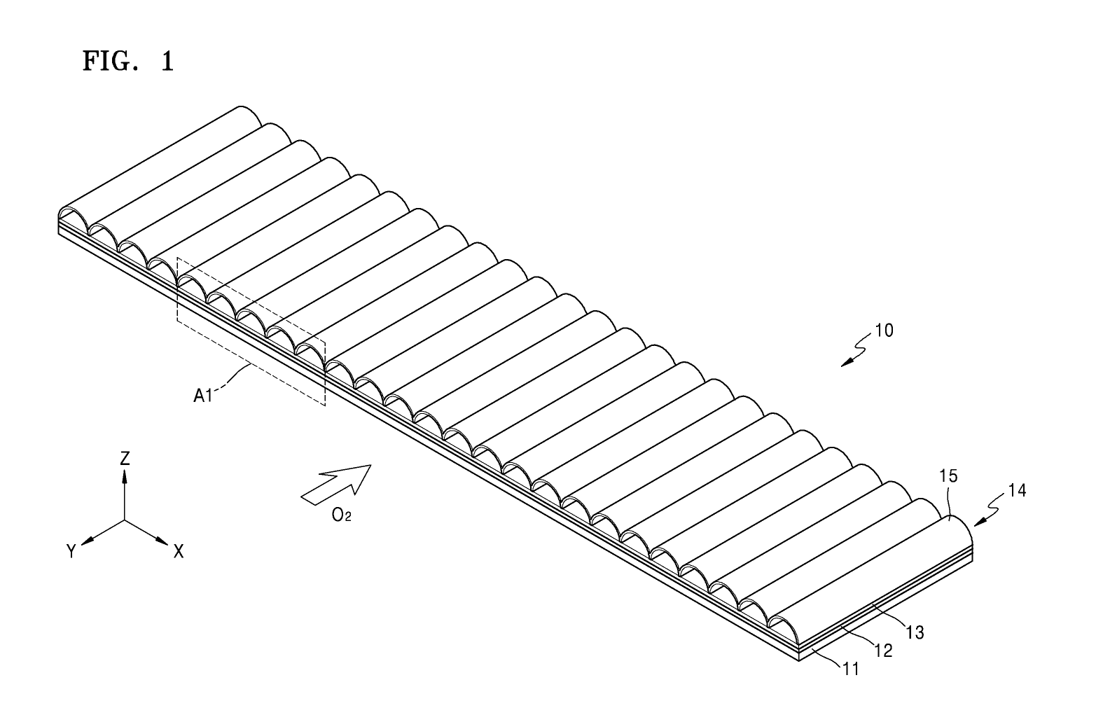

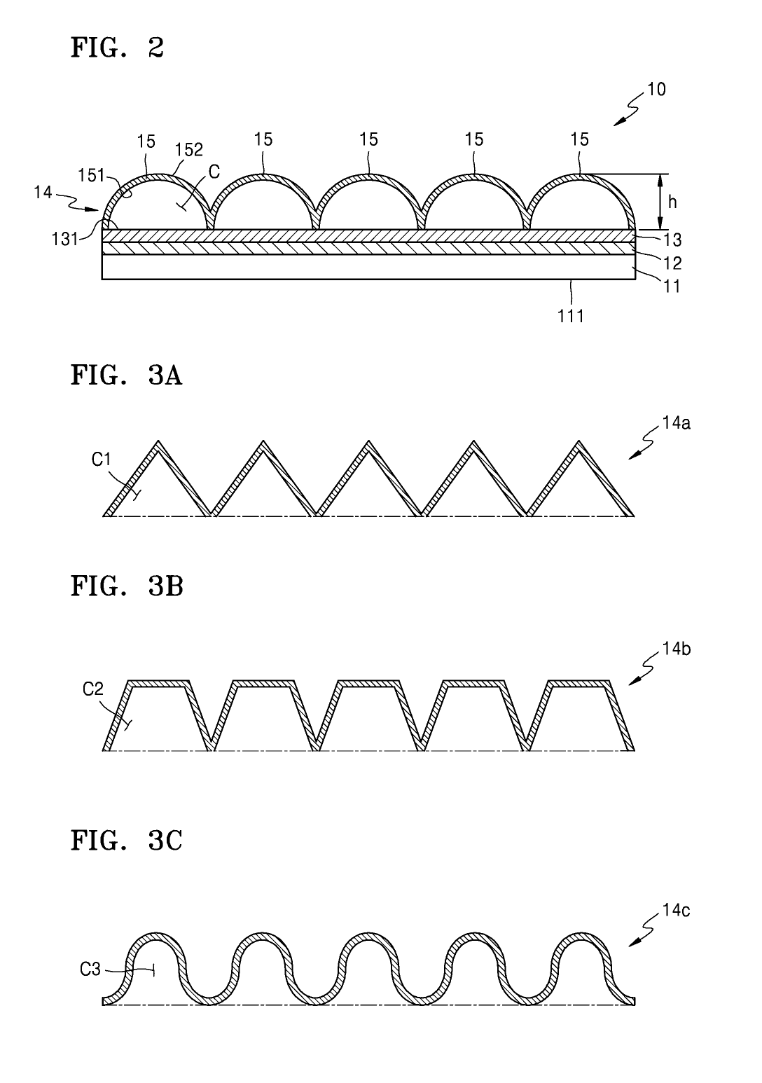

FIG. 1 is a perspective view schematically illustrating a metal-air battery cell 10, and FIG. 2 is an enlarged cross-sectional view illustrating portion A1 of the metal-air battery cell 10 illustrated in FIG. 1. FIGS. 3A to 3C are enlarged cross-sectional views illustrating modified examples of cavities of the metal-air battery cell illustrated in FIG. 2.

Referring to FIGS. 1 and 2, the metal-air battery cell 10 may include a negative electrode metal layer 11, a negative electrode electrolyte film 12 disposed on the negative electrode metal layer 11, a positive electrode layer 13 disposed on the negative electrode electrolyte film 12, and a channel layer 14 disposed on the positive electrode layer 13.

The negative electrode metal layer 11 may intercalate/deintercalate metal ions. In embodiments, for example, the negative electrode metal layer 11 may include or be formed of lithium (Li), sodium (Na), zinc (Zn), potassium (K), calcium (Ca), magnesium (Mg), iron (Fe), aluminum (Al) or an alloy thereof.

The negative electrode electrolyte film 12 may deliver metal ions to the positive electrode layer 13. The negative electrode electrolyte film 12 may include an electrolyte. In an embodiment of forming the electrolyte, a metal salt may be dissolved in a solvent. The electrolyte may be a solid electrolyte including a polymer electrolyte, an inorganic electrolyte, or a combination thereof, and may be prepared in such a manner that the electrolyte has flexibility. In embodiments, for example, the metal salt may be a lithium salt such as LiN(SO₂CF₂CF₃)₂, LiN(SO₂C₂F₅)₂, LiClO₄, LiBF₄, LiPF₆, LiSbF₆, LiAsF₆, LiCF₃SO₃, LiN(SO₂CF₃)₂, LiC(SO₂CF₃)₃, LiN(SO₃CF₃)₂, LiC₄F₉SO₃, LiAlCl₄ or LiTFSI (Lithium bis(trifluoromethanesulfonyl)imide). In addition to the lithium salt, the metal salt may further include another metal salt such as AlCl₃, MgCl₂, NaCl, KCl, NaBr, KBr, or CaCl₂. The solvent may be any of a number of solvents capable of dissolving the above-listed lithium salts and metal salts.

In addition, the negative electrode electrolyte film 12 may further include a separator impermeable with respect to oxygen and conductive with respect to metal ions. The separator may be a flexible polymer separator. In embodiments, for example, the separator may be a nonwoven polymer fabric such as a nonwoven polypropylene fabric or a nonwoven polyphenylene sulfide fabric, or may be a porous olefin-containing film such as a porous polyethylene film or a porous polypropylene film.

The separator and the electrolyte may form different layers within the negative electrode electrolyte film 12, or the separator (e.g., porous separator) may be impregnated with the electrolyte to form a single layer within the negative electrode electrolyte film 12. In an embodiment of forming the negative electrode electrolyte film 12, for example, pores of a porous separator may be impregnated with an electrolyte and the electrolyte may include a combination of polyethylene oxide (“PEO”) and LiTFSI.

The positive electrode layer 13 may include an electrolyte configured for conducting metal ions, a catalyst configured for oxidation/reduction of oxygen, a conductive material, and a binder. In an embodiment of forming the positive electrode layer 13, for example, the electrolyte, the catalyst, the conductive material and the binder may be combined with each other, and a solvent may be added to the combination to form a positive electrode slurry. Thereafter, the positive electrode slurry may be applied to the negative electrode electrolyte film 12 and dried to form the positive electrode layer 13.

The electrolyte of the positive electrode layer 13 may include the above-described lithium salt or metal salt. In embodiments, for example, the conductive material of the positive electrode layer 13 may be a porous material such as a carbon-containing material, a conductive metal material, a conductive organic material or a combination thereof. In embodiments, for example, the carbon-containing material may be carbon black, graphite, graphene, active carbon, carbon fiber or carbon nanotubes. In embodiments, for example, the conductive metal material may be metal powder. In embodiments, for example, the catalyst of the positive electrode layer 13 may be platinum (Pt), gold (Au) or silver (Ag). Alternatively, the catalyst may be an oxide of manganese (Mn), nickel (Ni), or cobalt (Co). In embodiments, for example, the binder of the positive electrode layer 13 may be polytetrafluoroethylene (“PTFE”), polypropylene, polyvinylidene fluoride (“PVDF”), polyethylene, or styrene-butadiene rubber (“SBR”).

The channel layer 14 is configured to cause air to flow on and be incident to the positive electrode layer 13. The channel layer 14 may include a plurality of channel structures 15 which defines the channel layer 14. Each of the channel structures 15 may form an independent channel through which air flows and may be elongated to extend in a direction crossing a direction (z-axis direction) in which the positive electrode layer 13 is disposed relative to other layers. The z-axis direction may otherwise be referred to as a laminating direction or a thickness direction. In an embodiment, for example, the channel structures 15 may be linearly elongated to extend in a y-axis direction as shown in FIG. 1. However, the channel structures 15 are not limited thereto. In another embodiment, for example, the channel structures 15 may be elongated to extend in a curved (e.g., non-linear) shape. The channel structures 15 may be arranged in a direction (x-axis direction) perpendicular to both the laminating direction (z-axis direction) of the positive electrode layer 13 and the extension direction (y-axis direction) of the channel structures 15. In an embodiment, for example, the channel layer 14 may be considered as having a corrugated shape defined by alternating ridges and grooves.

Each of the channel structures 15 may be convex in a direction (z-axis direction) taken away from an upper surface 131 of the positive electrode layer 13. Cavities C are defined by inner surfaces 151 of the convex channel structures 15 and the upper surface 131 of the positive electrode layer 13. The cavities C are elongated to extend in the same direction as the extension direction of the channel structures 15. Ambient air may be introduced into the cavities C through at least one of front and rear ends of each of the cavities C in the extension direction of the cavities C. Each of the front and rear ends of the cavity C may be open to outside the metal-air battery cell 10. In addition, ambient air may be introduced into the cavities C via the channel layer 14 depending on a material used to form the channel layer 14. In an embodiment, for example, the ambient air may be introduced into the cavities C by traveling through a thickness of the material forming the convex channel structure 15, such as into an outer surface 152, through the thickness and out of the inner surface 151 thereof.

Air introduced into the cavities C may make direct contact with the upper surface 131 of the positive electrode layer 13. Oxygen (O₂) included in the air is introduced into the cavities C. That is, the positive electrode layer 13 may smoothly make contact with oxygen (O₂) included in air which is introduced via the channel layer 14 to the positive electrode layer 13.

As described above, since oxygen (O₂) is smoothly supplied to the positive electrode layer 13 through the channel layer 14, an additional space for generating air flow is not required at a position above the channel layer 14 (e.g., further in the direction away from an upper surface 131 of the positive electrode layer 13). That is, a second metal-air battery cell 10 may be brought into contact with an upper side of the channel layer 14 of an underlying first metal-air battery cell 10. Therefore, since a plurality of metal-air battery cells 10 can be disposed in the z-axis direction, a larger number of metal-air battery cells 10 may be disposed in a given planar area defined in the x-axis and y-axis directions.

In addition, the metal-air battery cell 10 may be cooled more efficiently owing to the channel layer 14. During operation of the metal-air battery cell 10, heat may be generated when the positive electrode layer 13 is oxidized. According to the illustrated embodiment, since air making direct contact with the positive electrode layer 13 flows in the cavities C of the channel layer 14, overheating of the positive electrode layer 13 may be reduced or effectively prevented.

The cavities C may have various cross-sectional shapes or profiles as long as the cavities C are convex with reference to the upper surface 131 of the positive electrode layer 13.

In an embodiment, for example, the cavities C may have a semicircular cross-sectional shape as shown in FIG. 2. In other embodiments, cavities C1, C2 and C3 of channel layers 14a, 14b and 14c may have a polygonal triangular shape, a polygonal rectangular shape, or a wave-form shape as shown in FIGS. 3A, 3B and 3C, respectively. Within each of the embodiments of the channel layers 14, 14a, 14b and 14c, each group of the cavities C, C1, C2 and C3 have the same shape. However, the present invention is not limited thereto. In alternative embodiments, for example, a portion of the group of cavities C, C1, C2 and C3 within a channel layer 14, 14a, 14b and 14c may have a size and/or shape different from a remainder of the group.

The channel layer 14 may include or be formed of any of a number of materials as long as a convex profile and the shape of the channel structures 15 is maintained. In an embodiment, for example, the channel layer 14 may include a material including one selected from porous metals, porous ceramic materials, porous polymers, porous carbon materials, porous light metals and combinations thereof. Since the channel layer 14 has a porous structure, the channel layer 14 may absorb oxygen (O₂) included in the air and smoothly diffuse the oxygen (O₂) into the cavities C. Examples of the porous metals may include foam metals having a sponge shape, and metal fiber mats. Examples of the porous carbon materials may include carbon paper, carbon cloth, and carbon felt that are formed of carbon fibers. Examples of the porous ceramic materials may include magnesium-aluminum silicate. Examples of the porous polymers may include porous polyethylene and porous polypropylene. Examples of the porous light metals may include nickel meshes, and flexible composite materials made of polymers and nickel meshes.

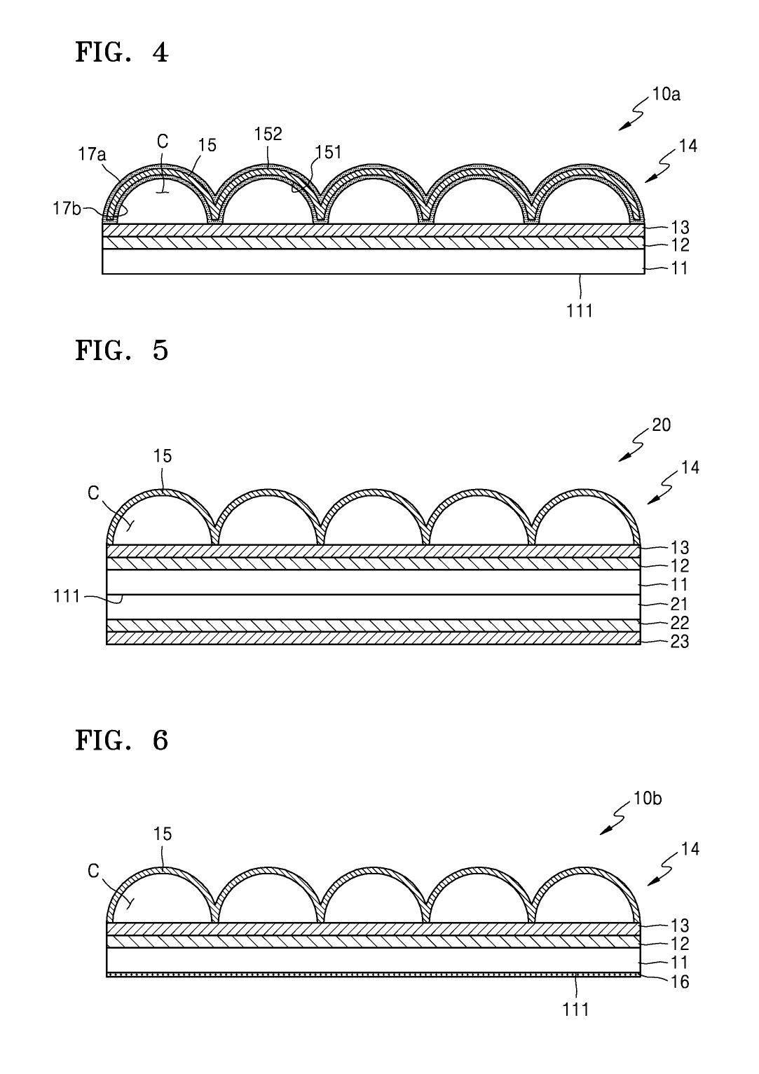

FIG. 4 is a cross-sectional view illustrating a metal-air battery cell in which sub positive electrode layers are disposed on a channel layer according to an embodiment of the present invention.

Sub positive electrode layers 17a and 17b configured to use oxygen (O₂) as an active material may be disposed on surface portions of the channel layer 14. FIG. 4 illustrates a metal-air battery cell 10a in which sub positive electrode layers 17a and 17b are disposed on a channel layer 14 according to an embodiment. Referring to FIG. 4, the sub positive electrode layers 17a and 17b using oxygen (O₂) as an active material may be respectively disposed on the outer surface 152 and the inner surface 151 of the channel layer 14. Owing to the sub positive electrode layers 17a and 17b, a larger total planar area of the metal-air battery cell 10a may be structurally brought into contact with oxygen (O₂).

The sub positive electrode layers 17a and 17b may make direct contact with a positive electrode layer 13 and may be electrically connected to the positive electrode layer 13. In an embodiment, for example, the sub positive electrode layer 17b may be disposed between the channel structure 15 and the positive electrode layer 13. The sub positive electrode layer 17b may extend between adjacent cavities C and/or extend from endmost cavities C to be connected to the sub positive electrode layer 17a.

The sub positive electrode layers 17a and 17b may include an electrolyte configured for conducting metal ions, a catalyst configured for oxidation/reduction of oxygen (O₂), a conductive material, and a binder. The channel layer 14 and the sub positive electrode layers 17a and 17b may collectively form a single layer (e.g., monolayer) or may define a plurality of different layers as shown in FIG. 4. In an embodiment of forming a sub positive electrode layer, for example, the electrolyte, the catalyst, the conductive material and the binder may be combined, and a solvent may be added to the combination to form a positive electrode slurry. Thereafter, the positive electrode slurry may be applied to the channel layer 14 and dried to form the sub positive electrode layers 17a and 17b. The sub positive electrode layers 17a and 17b may include the same material as each other and/or as the positive electrode layer 13. In an embodiment of forming the sub positive electrode layers 17a and 17b, a same material as that used to form the positive electrode layer 13 may form the sub positive electrode layers 17a and 17b.

Referring back to FIG. 2, the channel layer 14 may function as a buffer when an overall thickness of the metal-air battery cell 10 is changed during a charging/discharging operation thereof.

In the metal-air battery cell 10, at least one selected from the positive electrode layer 13 and the negative electrode metal layer 11 may vary in thickness during a charging/discharging operation of the metal-air battery cell 10. A thickness of the negative electrode metal layer 11 may decrease during a discharging operation and may increase during a charging operation. A thickness of the positive electrode layer 13 may increase during a discharging operation and may decrease during a charging operation.

When the thickness of at least one of the negative electrode metal layer 11 and the positive electrode layer 13 varies during a charging or discharging operation as described above, an overall height h (refer to FIG. 1) of the channel layer 14 may vary according to thickness variations of the negative electrode metal layer 11 and the positive electrode layer 13 within the metal-air battery cell 10. The overall height h of the channel layer 14 refers to the distance between the upper surface 131 of the positive electrode layer 13 and an apex of the channel layer 14, or a maximum distance between the positive electrode layer 13 and the channel layer 14. Since the overall height h of the channel layer 14 is variable, the formation of metal dendrites in the negative electrode metal layer 11 may be suppressed.

The overall height h of the channel layer 14 may easily vary during a charging or discharging operation as described above owing to the structure thereof. Since the channel layer 14 includes the channel structures 15 forming the cavities C, the overall height h of the channel layer 14 may easily vary during a charging or discharging operation as described above as compared with a flat structure during a charging or discharging operation.

The channel layer 14 may include or be formed of an elastic material. Where the channel layer 14 includes elastic material, the overall height h of the channel layer 14 may vary more easily during a charging or discharging operation as described above owing to the elasticity thereof. Examples of the elastic material may include elastic polymers. Examples of the elastic polymers may include polyvinylidene fluoride (“PVDF”), a copolymer of vinylidene fluoride and hexafluoro propylene (“PVDF-HFP”), a copolymer of styrene/butadiene (“SBR”), polyethylene oxides (“PEO”), copolymers of ethylene oxides, and copolymers thereof. In addition, any of a number materials (such as metal wires (formed of shape memory alloys), metal meshes, or rubber) usable to form an elastic structure may be unlimitedly used to form the channel layer 14.

FIG. 5 is a cross-sectional view illustrating a metal-air battery cell 20 according to another embodiment of the present invention. Elements of the metal-air battery cell 20 of FIG. 5 identical to those of the metal-air battery cell 10 of FIG. 2 are denoted by the same reference numerals, and descriptions thereof are not repeated.

Referring to FIG. 5, the metal-air battery cell 20 may further include a second negative electrode metal layer 21 disposed under a negative electrode metal layer 11, a second negative electrode electrolyte film 22 disposed under the second negative electrode metal layer 21, and a second positive electrode layer 23 disposed under the second negative electrode electrolyte film 22.

The second negative electrode metal layer 21 may intercalate/deintercalate metal ions. In embodiments, for example, the second negative electrode metal layer 21 may include or be formed of lithium (Li), sodium (Na), zinc (Zn), potassium (K), calcium (Ca), magnesium (Mg), iron (Fe), aluminum (Al), or an alloy thereof. The second negative electrode metal layer 21 and the negative electrode metal layer 11 may form and define different distinct layers within the metal-air battery cell 20. However, the invention is not limited thereto. In an alternative embodiment, for example, the second negative electrode metal layer 21 and the negative electrode metal layer 11 may collectively form a single layer (e.g., monolayer) among layers of the metal-air battery cell 20.

The second negative electrode electrolyte film 22 may deliver metal ions to the second positive electrode layer 23. The second negative electrode electrolyte film 22 may include an electrolyte. In an embodiment of forming the electrolyte, a metal salt may be dissolved in a solvent. The electrolyte may be a solid electrolyte including a polymer electrolyte, an inorganic electrolyte, or a combination thereof, and may be prepared in such a manner that the electrolyte has flexibility. In embodiments, for example, the metal salt may be a lithium salt such as LiN(SO₂CF₂CF₃)₂, LiN(SO₂C₂F₅)₂, LiClO₄, LiBF₄, LiPF₆, LiSbF₆, LiAsF₆, LiCF₃SO₃, LiN(SO₂CF₃)₂, LiC(SO₂CF₃)₃, LiN(SO₃CF₃)₂, LiC₄F₉SO₃, LiAlCl₄ or LiTFSI (Lithium bis(trifluoromethanesulfonyl)imide). In addition to the lithium salt, the metal salt may further include another metal salt such as AlCl₃, MgCl₂, NaCl, KCl, NaBr, KBr, or CaCl₂. The solvent may be any of a number of solvents capable of dissolving the above-listed lithium salts and metal salts.

In addition, the second negative electrode electrolyte film 22 may further include a separator impermeable with respect to oxygen (O₂) and conductive with respect to metal ions. The separator may be a flexible polymer separator. In embodiments, for example, the separator may be a nonwoven polymer fabric such as a nonwoven polypropylene fabric or a nonwoven polyphenylene sulfide fabric, or may be a porous olefin-containing film such as a porous polyethylene film or a porous polypropylene film.

The separator and the electrolyte may form different layers within the negative electrode electrolyte film 22, or the separator (e.g., porous separator) may be impregnated with the electrolyte to form a single layer within the negative electrode electrolyte film 22. In an embodiment of forming the second negative electrode electrolyte film 22, for example, pores of a porous separator may be impregnated with an electrolyte and the electrolyte may include a combination of polyethylene oxide (“PEO”) and LiTFSI. In an embodiment, for example, the second negative electrode electrolyte film 22 may include and/or be formed of the same material used to form the (first) negative electrode electrolyte film 12.

The second positive electrode layer 23 may include an electrolyte configured for conducting metal ions, a catalyst configured for oxidation/reduction of oxygen (O₂), a conductive material, and a binder. In an embodiment of forming the second positive electrode layer 23, for example, the electrolyte, the catalyst, the conductive material and the binder may be combined with each other, and a solvent may be added to the combination to form a positive electrode slurry. Thereafter, the positive electrode slurry may be applied to the second negative electrode electrolyte film 22 and dried to form the second positive electrode layer 23.

A (first) negative electrode electrolyte film 12 is disposed on top of the (first) negative electrode metal layer 11, and the second negative electrode metal layer 21 and the second negative electrode electrolyte film 22 are disposed under the (first) negative electrode metal layer 11. Therefore, contact of the (first) negative electrode metal layer 11 with oxygen (O₂) may be reduced or effectively prevented.

FIG. 6 is a cross-sectional view illustrating a metal-air battery cell 10b in which contact of a lower side of a negative electrode metal layer 11 with oxygen (O₂) is reduced or effectively prevented according to another embodiment of the present invention.

Referring to FIG. 6, an oxygen blocking layer 16 may be disposed under the negative electrode metal layer 11. The oxygen blocking layer 16 may reduce or effectively prevent permeation of oxygen (O₂) into the negative electrode metal layer 11. That is, the oxygen blocking layer 16 disposed under the negative electrode metal layer 11 may reduce or effectively prevent contact between oxygen (O₂) and the lower side of the negative electrode metal layer 11. The oxygen blocking layer 16 may include or be formed of polyethylene terephthalate.

In the embodiments shown in FIGS. 1 to 6, the metal-air battery cells 10, 10a, 10b and 20 have a substantially flat shape. However, the metal-air battery cells 10, 10a, 10b and 20 are not limited thereto. In embodiments, for example, one or more layers within the metal-air battery cells 10, 10a, 10b and 20 may be deformed or bent such that the metal-air battery cells 10, 10a, 10b and 20 in a deformed or bent state do not have a flat shape.

The one or more layers that may be deformed or bent may include, but are not limited to, the negative electrode metal layer 11, the negative electrode electrolyte film 12, the positive electrode layer 13 and the channel layer 14.

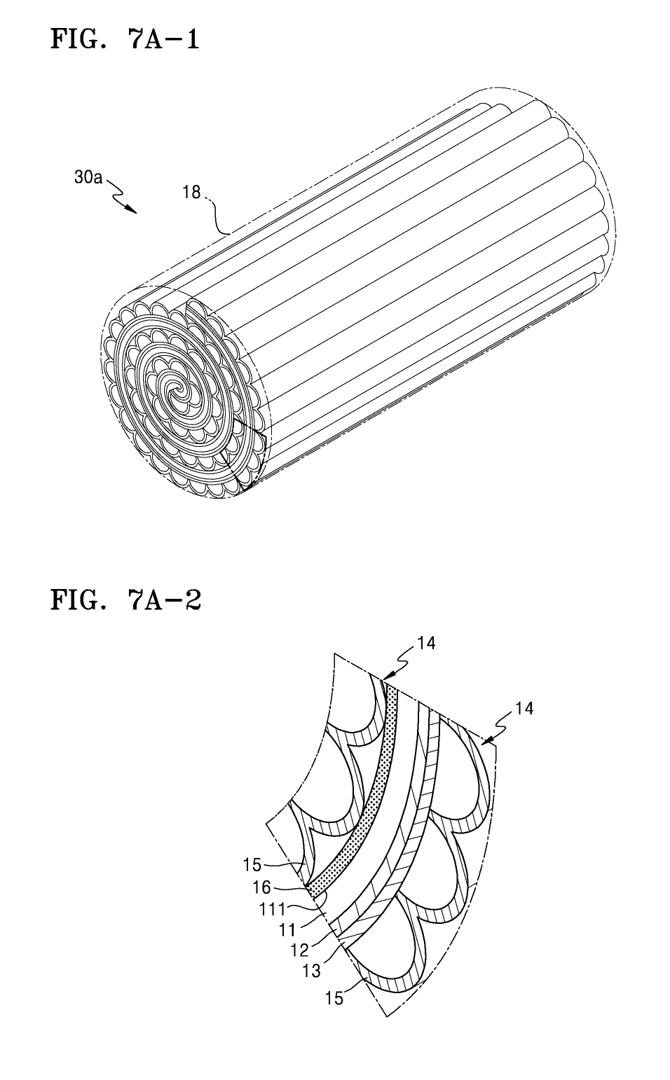

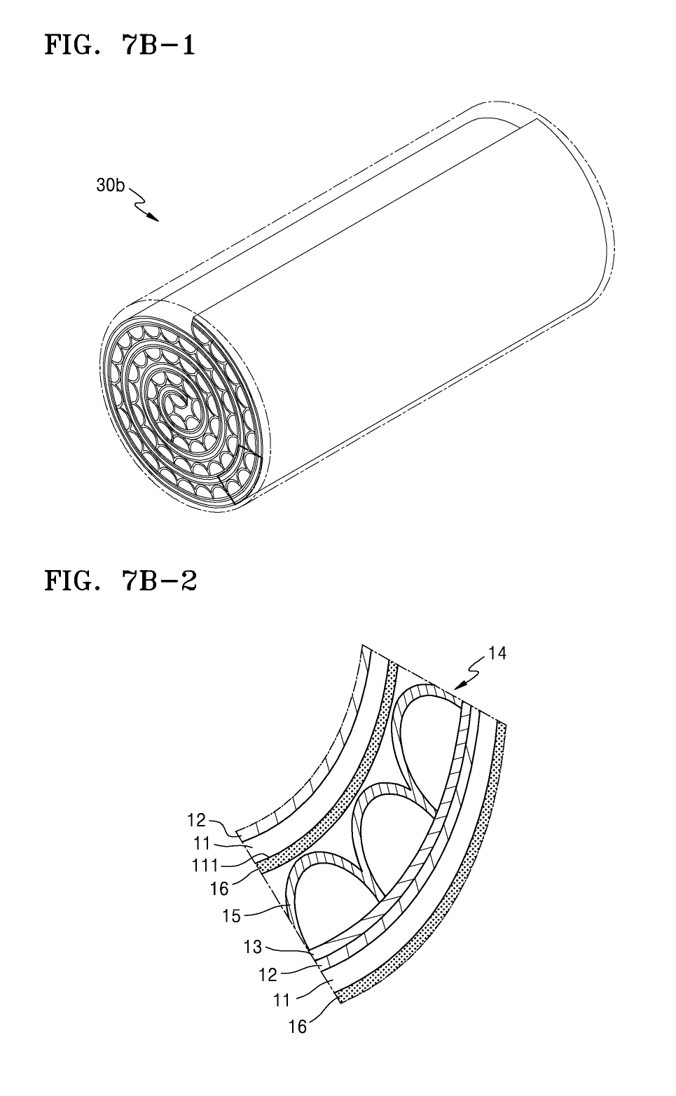

FIGS. 7A_1, 7A_2, 7B_1 and 7B_2 illustrate examples in which the metal-air battery cell 10 illustrated in FIG. 1 is bent. Referring to FIGS. 7A_1 and 7B_1, the negative electrode metal layer 11, the negative electrode electrolyte film 12, the positive electrode layer 13 and the channel layer 14 of a metal-air battery cell (denoted by reference numerals 30a and 30b in FIGS. 7A_1 and 7B_1, respectively) may be rolled up. The metal-air battery cells 30a and 30b may represent any one of the above-described metal-air battery cells 10, 10a, 10b and 20 in a rolled-up state. FIGS. 1, 4, 5 and 6 illustrate the metal-air battery cells 10, 10a, 10b and 20 in a flat (e.g., un-bent or un-rolled state).

Referring to FIGS. 7A_2 and 7B_2, for example, the negative electrode metal layer 11, the negative electrode electrolyte film 12, the positive electrode layer 13 and the channel layer 14 of the metal-air battery cell 30a and 30b may be bent from a flat state thereof in such a manner that the negative electrode metal layer 11 is disposed on top of the channel layer 14 in a direction away from a center of the roll. An axis of the metal-air battery cell 30a and 30b may be defined at the center of the roll. The continuously extended negative electrode metal layer 11, the negative electrode electrolyte film 12, the positive electrode layer 13 and the channel layer 14 may be bent about such axis to form the metal-air battery cell 30a and 30b in a rolled state. In the bent or rolled state of the metal-air battery cell 30a, a lower surface 111 of the negative electrode metal layer 11 may be disposed on top of the channel layer 14 and further from the center of the roll one or more times along the direction away from the center of the roll.

The metal-air battery cell may be rolled up in such a manner that the channel layer 14 is disposed outward and further from the center of the roll than the negative electrode layer 11 as shown in FIGS. 7A_1 and 7A_2 (denoted by reference numeral 30a). Alternatively, the negative electrode metal layer 11 is disposed outward and further from the center of the roll than the channel layer 14 as shown in FIGS. 7B_1 and 7B_2 (denoted by reference numeral 30b).

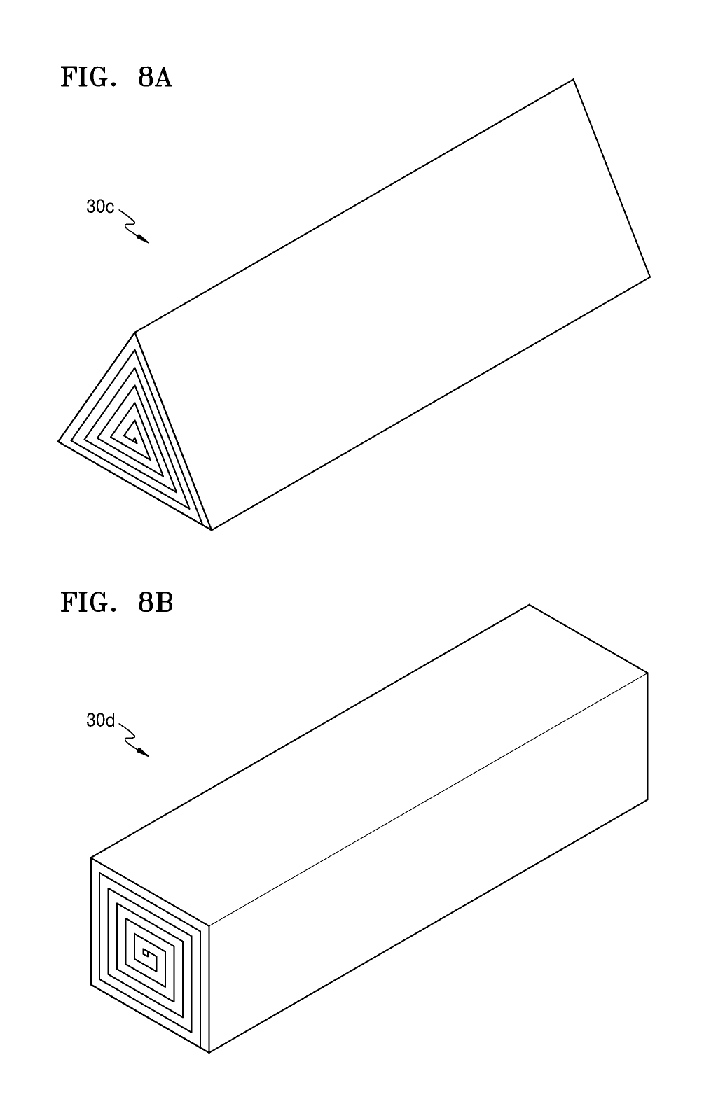

The negative electrode metal layer 11, the negative electrode electrolyte film 12, the positive electrode layer 13 and the channel layer 14 may be rolled up into a roll. That is, the metal-air battery cells 30a and 30b illustrate the form of a roll. The roll may have an overall cylindrical shape as shown in FIGS. 7A_1 and 7B_1. However, the present invention is not limited thereto. In alternative embodiments, for example, metal-air battery cells 30c and 30d having a polygonal pillar shape such as a triangular or rectangular pillar shape may be formed as shown in FIGS. 8A and 8B. The metal-air battery cells 30c and 30d may represent any one of the above-described metal-air battery cells 10, 10a, 10b and 20 in a rolled-up state. The metal-air battery cells 30c and 30d shown in FIGS. 8A and 8B have the same layers as those shown in FIG. 7A_1, 7A_2, 7B_1 and 7B_2, and thus each individual or discrete layer thereof is not specifically illustrated.

Referring to back FIG. 7A_1, 7A_2 7B_1 and 7B_2, an oxygen blocking layer 16 (refer to FIG. 6) may be disposed between the negative electrode metal layer 11 and the channel layer 14. Owing to the oxygen blocking layer 16, contact of oxygen (O₂) included in air introduced into the channel layer 14 with the negative electrode metal layer 11 may be reduced or effectively prevented. The oxygen blocking layer 16 may be disposed within any one of the above-described metal-air battery cells 10, 10a and 10b.

Referring again to FIGS. 7A_1 and 7A_2, a shape maintaining film 18 may be wound around the metal-air battery cell 30a that is in the form of a roll. The shape maintaining film 18 may maintain the shape of the metal-air battery cell 30a even though the thicknesses of the negative electrode metal layer 11 and the positive electrode layer 13 vary during a charging/discharging operation. Since the shape of the metal-air battery cell 30a is maintained by the shape maintaining film 18, the formation of dendrites in the negative electrode metal layer 11 may be suppressed. The shape maintaining film 18 may be disposed around any one of the rolled-up metal-air battery cells 30a, 30b, 30c and 30d, such that the shape thereof is maintained even though thicknesses of layers therein vary during a charging/discharging operation thereof.

Metal-air battery cells having only a portion of the layers thereof in a bent state illustrate other examples of metal-air battery cells in which less than all layers are in a bent state. In embodiments, for example, among layers of a metal-air battery cells, a negative electrode metal layer 11, a negative electrode electrolyte film 12 and a positive electrode layer 13 may be bent while remaining layers may be in an un-bent state.

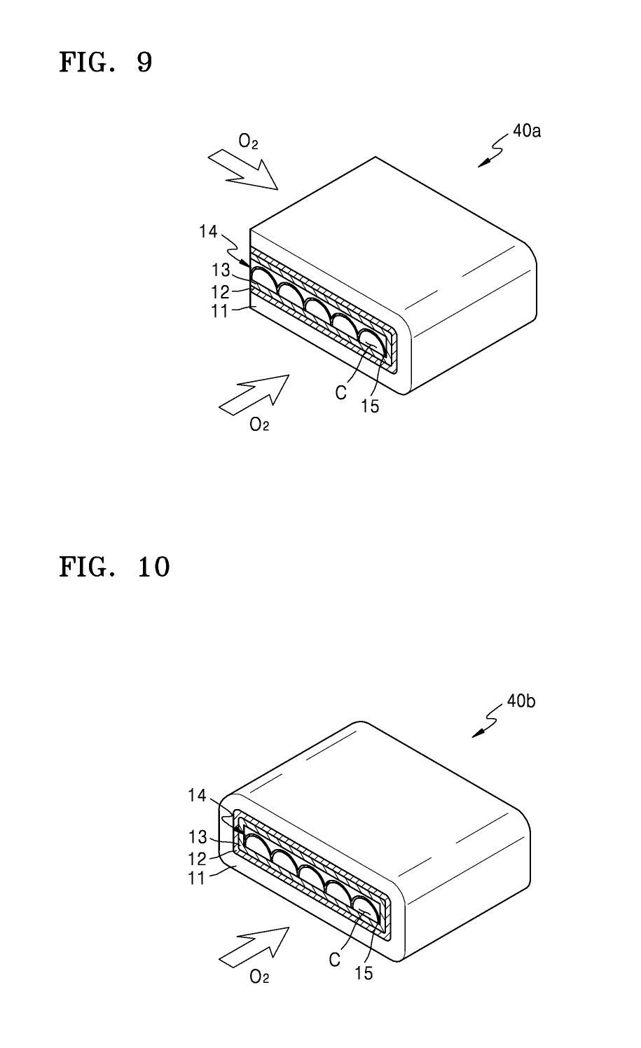

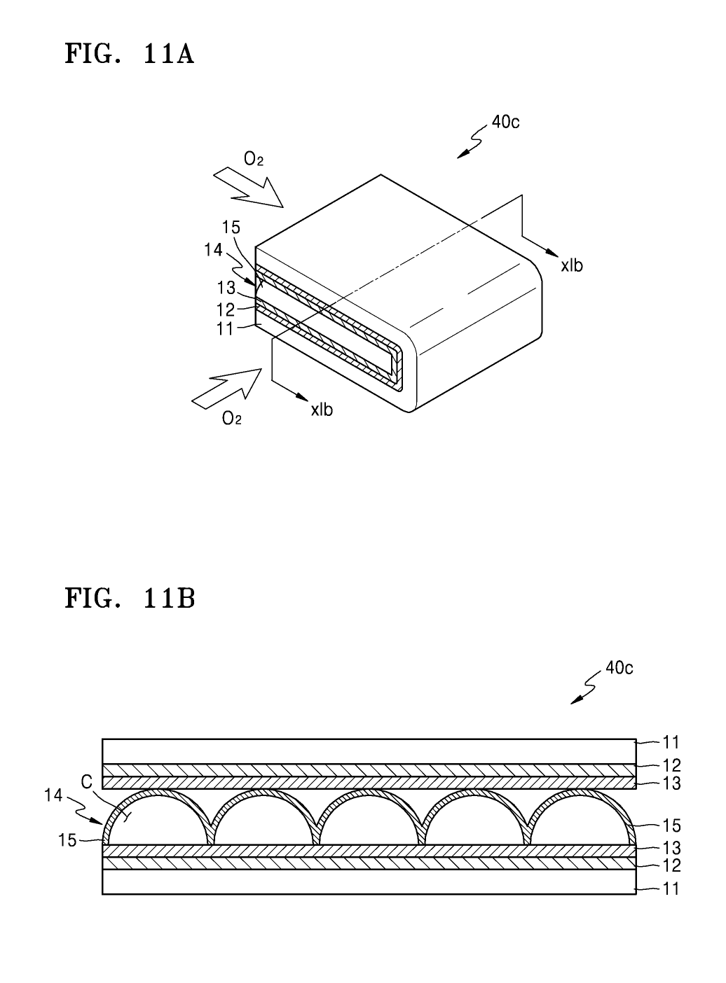

FIGS. 9, 10 and 11A are perspective views illustrating metal-air battery cells each including a negative electrode metal layer, a negative electrode electrolyte film and a positive electrode layer that are bent according to embodiments of the present invention, and FIG. 11B is a cross-sectional view of the metal-air battery cell illustrated in FIG. 11A taken along xlb-xlb.

Referring to FIGS. 9, 10 and 11A, the negative electrode metal layer 11, the negative electrode electrolyte film 12 and the positive electrode layer 13 among layers of each of the metal-air battery cells 40a, 40b and 40c are in a bent state according to embodiments of the present invention. FIG. 11B is a cross-sectional view illustrating the metal-air battery cell 40c illustrated in FIG. 11A taken along xlb-xlb. In each of FIGS. 9, 10 and 11A, the negative electrode metal layer 11, the negative electrode electrolyte film 12 and the positive electrode layer 13 are bent upward toward the channel layer 14 such that the positive electrode layer 13 may make contact with an upper side of a channel layer 14.

Referring to FIG. 9, in the metal-air battery cell 40a, the negative electrode metal layer 11, the negative electrode electrolyte film 12 and the positive electrode layer 13 may be continuously extended and bent to cover lower, right and upper sides of the channel layer 14. The lower side of the channel layer 14 refers to an imaginary plane connecting lowermost points of channel structures 15 of the channel layer 14, and the upper side of the channel layer 14 refers to an imaginary plane connecting uppermost points of the channel structures 15 of the channel layer 14.

In a flat state of the metal-air battery cell 40a, the negative electrode metal layer 11, the negative electrode electrolyte film 12 and the positive electrode layer 13 may extend further than the channel layer 14, such that portions thereof are exposed from the channel layer 14. In an embodiment of forming the bent-state metal-air battery cell 40a illustrated in FIG. 9, after the channel layer 14 is disposed on top of a portion of the positive electrode layer 13, the negative electrode metal layer 11, the negative electrode electrolyte film 12 and the positive electrode layer 13 may be bent upward such as toward the channel layer 14 such that the positive electrode layer 13 may make contact with the upper side of the channel layer 14. The above-described forming method may be applied to any one of the metal-air battery cells 40a, 40b and 40c.

Referring to FIG. 9, in this bent-state structure, front and rear ends of the channel layer 14 in an extension direction of the channel layer 14, and a left side of the channel layer 14 may be exposed to outside the metal-air battery cell 40a. At the exposed ends and sides of the bent-state metal-air battery cell 40a, air may be incident to a layer thereof.

Referring to FIG. 10, the negative electrode metal layer 11, the negative electrode electrolyte film 12 and the positive electrode layer 13 may be bent to cover lower, right, upper and left sides of the channel layer 14. In this bent-state structure, only the front and rear ends of the channel layer 14 in an extension direction of channel structures 15 of the channel layer 14 may be exposed to outside the metal-air battery cell 40b. An extension direction of each of the negative electrode metal layer 11, the negative electrode electrolyte film 12 and the positive electrode layer 13 is perpendicular to the extension direction of the channel structures 15. That is, sides of the channel layer 14 are not exposed to outside the metal-air battery cell 40b.

Refers to FIGS. 11A and 11B, the negative electrode metal layer 11, the negative electrode electrolyte film 12 and the positive electrode layer 13 may be bent to cover upper and lower sides of the channel layer 14 and a first end of the channel layer 14 in an extension direction of channel structures 15 of the channel layer 14. An extension direction of each of the negative electrode metal layer 11, the negative electrode electrolyte film 12 and the positive electrode layer 13 is parallel to the extension direction of the channel structures 15. In this bent-state structure of the metal-air battery cell 40c, an opposing second end of the channel layer 14 in the extension direction of the channel structures 15 may be exposed to outside the metal-air battery cell 40c.

According to an embodiment of the present invention, a metal-air battery includes a plurality of metal-air battery cells. The energy density of the metal-air battery may be determined according to the number of the metal-air battery cells integrated in a given area. An explanation will now be given of how the metal-air battery cells are integrated in the metal-air battery according to embodiments of the present invention. The metal-air battery cells are not limited to the metal-air battery cell 10 illustrated in FIG. 2. In embodiments, for example, the metal-air battery cells of the metal-air battery may be any one of the metal-air battery cells 10a, 10b, 20, 30a, 30b, 30c, 30d, 40a, 40b or 40c illustrated in FIGS. 4 to 11A.

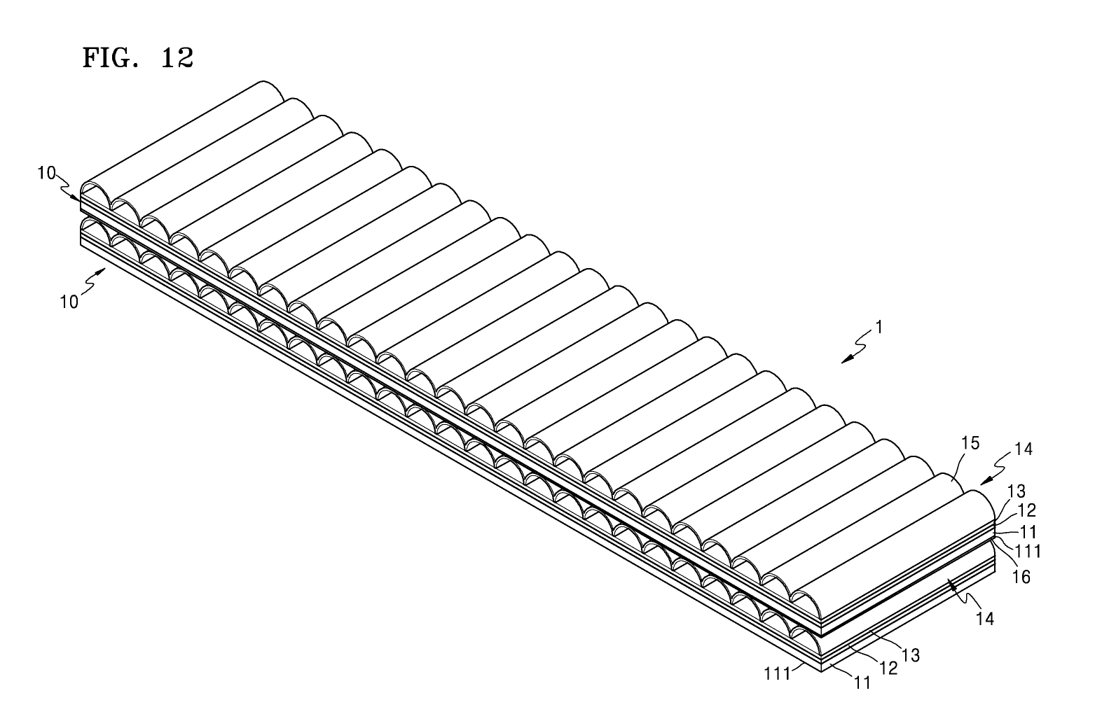

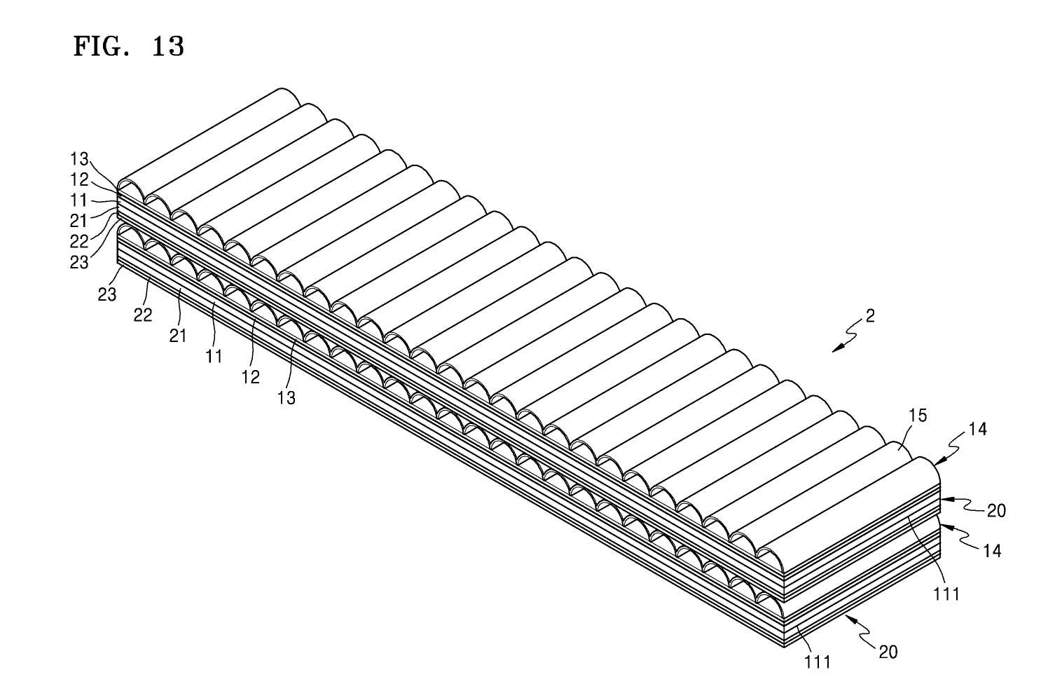

FIG. 12 is a perspective view illustrating a metal-air battery 1 including a plurality of metal-air battery cells 10 such as the metal-air battery cell 10 illustrated in FIG. 1 according to an embodiment of the present invention, and FIG. 13 is a perspective view illustrating a metal-air battery 2 including a plurality of metal-air battery cells 20 such as the metal-air battery cell 20 illustrated in FIG. 5 according to an embodiment of the present invention. In FIGS. 12 and 13, two metal-air battery cells 10 and two metal-air battery cells 20 are illustrated. However, the number of the metal-air battery cells 10 and 20 are not limited thereto. In an embodiment, for example, three or more metal-air battery cells 10 and three or more metal-air battery cells 20 may be arranged in similar manners for the metal-air battery 1 and 2, respectively.

Referring to FIG. 12, the metal-air battery 1 includes a first (lower) metal-air battery cell 10 and a second (upper) metal-air battery cell 10. The second metal-air battery cell 10 is disposed on top of the first metal-air battery cell 10. As described above, each of the first and second metal-air battery cells 10 includes a negative electrode metal layer 11, a negative electrode electrolyte film 12, a positive electrode layer 13 and a channel layer 14.

The second metal-air battery cell 10 may be disposed on the channel layer 14 of the first metal-air battery cell 10. Since it is unnecessary to form an additional space above the channel layer 14 of the first metal-air battery cell 10, the second metal-air battery cell 10 may be directly disposed on the channel layer 14 of the first metal-air battery cell 10.

An oxygen blocking layer 16 may be disposed between the channel layer 14 of the first metal-air battery cell 10 and the negative electrode metal layer 11 of the second metal-air battery cell 10, but the invention is not limited thereto. The oxygen blocking layer 16 reduces or effectively prevents oxygen-containing air from moving from the channel layer 14 of the first metal-air battery cell 10 to the negative electrode metal layer 11 of the second metal-air battery cell 10. Therefore, the negative electrode metal layer 11 may make contact with a minimal amount of oxygen (O₂).

Referring to FIG. 13, a second (upper) metal-air battery cell 20 may be disposed on top of a first (lower) metal-air battery cell 20. Each of the first and second metal-air battery cells 20 includes a channel layer 14, a positive electrode layer 13, a negative electrode electrolyte film 12, a negative electrode metal layer 11, a second negative electrode metal layer 21, a second negative electrode electrolyte film 22 and a second positive electrode layer 23. Since the second negative electrode electrolyte film 22 and the second positive electrode layer 23 are disposed under the (first) negative electrode metal layer 11 and second negative electrode metal layer 21, the (first) negative electrode metal layer 11 and the second negative electrode metal layer 21 do not make direct contact with oxygen (O₂) included in air flowing through the channel layer 14. Therefore, unlike the embodiment shown in FIG. 12, oxidation of the negative electrode metal layer 11 may be reduced or effectively prevented without using an oxygen blocking layer 16.

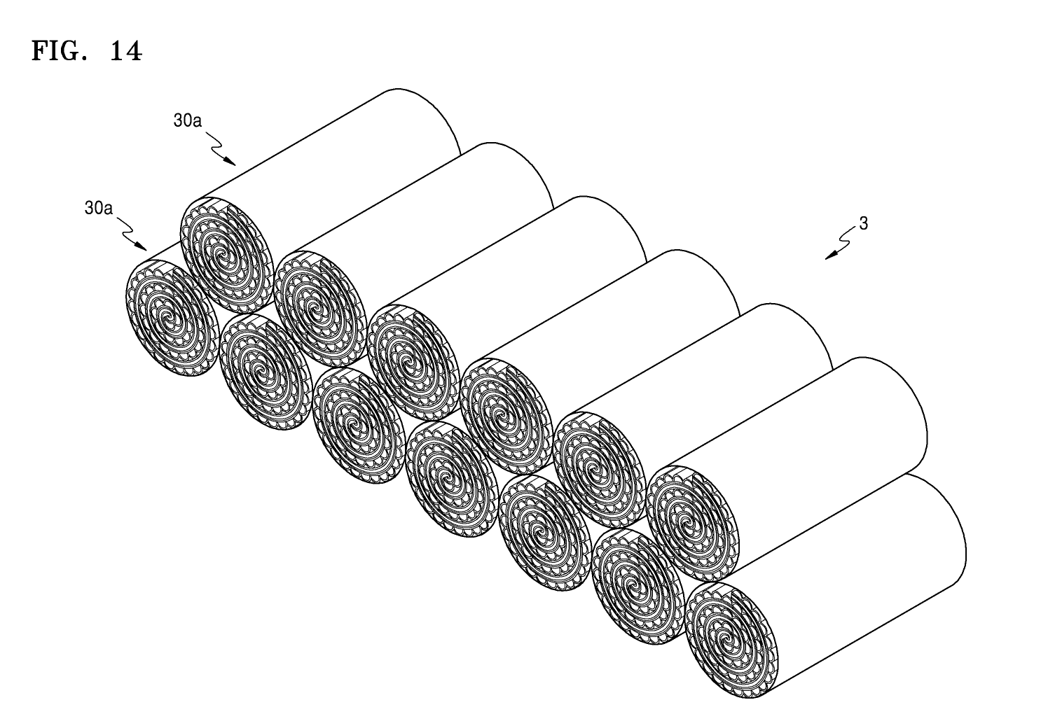

FIG. 14 is a perspective view illustrating an exemplary metal-air battery 3 including a plurality of metal-air battery cells 30a such as the metal-air battery cell 30a illustrated in FIGS. 7A_1 and 7A_2. Referring to FIG. 14, the metal-air battery cells 30a may be stacked in such a manner that at least one of front and rear ends of each of the metal-air battery cells 30a in an extension direction of channel structures 15 is exposed to the outside. In an embodiment, for example, the metal-air battery cells 30a that are each in the form of a roll may be arranged in such a manner that at least portions of lateral sides of the metal-air battery cells 30a are in contact with each other.

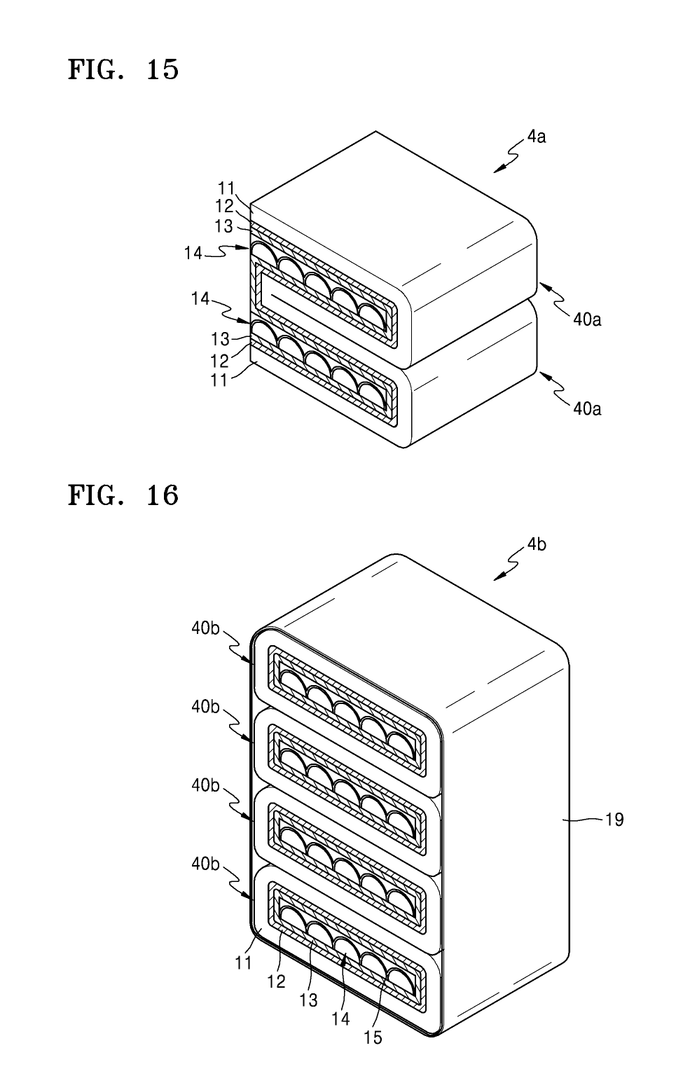

FIG. 15 is a perspective view illustrating an exemplary metal-air battery 4a including a plurality of metal-air battery cells 40a such as the metal-air battery cell 40a illustrated in FIG. 9. Referring to FIG. 15, the metal-air battery 4a may include a plurality of channel layers 14, for example, two individual channel layers 14. A continuously extended single negative electrode metal layer 11, single negative electrode electrolyte film 12 and single positive electrode layer 13 may each be bent to cover three sides of each of the channel layers 14.

In an embodiment of forming the metal-air battery 4a, for example, among the plurality of channel layers 14, a first channel layer 14 may be disposed on top of a portion of the positive electrode layer 13, and the negative electrode metal layer 11, the negative electrode electrolyte film 12, and the positive electrode layer 13 may be bent upward to the first channel layer 14 such that the positive electrode layer 13 may make contact with an upper side of the first channel layer 14.

Thereafter, the negative electrode metal layer 11, the negative electrode electrolyte film 12 and the positive electrode layer 13 are bent 180 degrees in an opposite direction such that the positive electrode layer 13 may face upward. Then, among the plurality of channel layers 14, a second channel layer 14 is disposed on top of the bent positive electrode layer 13 facing upward, and the negative electrode metal layer 11, the negative electrode electrolyte film 12 and the positive electrode layer 13 are bent upward to the second channel layer 14 such that the positive electrode layer 13 may make contact with an upper side of the second channel layer 14.

In the metal-air battery 4a only the negative electrode metal layer 11 may be exposed at the right side of the metal-air battery 4a, and each of the negative electrode electrolyte film 12, the positive electrode layer 13 and the channel layers 14 may be exposed at the left side opposite to the right side of the metal-air battery 4a. Therefore, oxygen (O₂) necessary for oxidation/reduction at the positive electrode layer 13 may be absorbed into front and rear ends of the channel layers 14 in an extension direction of the channel layers 14 and into the left sides of the channel layers 14, and the absorbed oxygen (O₂) may be supplied to the entirety of the positive electrode layer 13.

FIG. 16 is a perspective view illustrating an exemplary metal-air battery 4b including a plurality of metal-air battery cells 40b such as the metal-air battery cell 40b illustrated in FIG. 10. Referring to FIG. 16, the metal-air battery 4b includes the metal-air battery cells 40b. The individual metal-air battery cells 40b may be stacked in such a manner that outer negative electrode metal layers 11 may make contact with each other.

The collection of individual metal-air battery cells 40b may be surrounded with an outer casing 19. The outer casing 19 may prevent oxidation of the negative electrode metal layers 11 disposed at an outermost portion of each of the individual metal-air battery cells 40b. The metal-air battery cells 40b may be disposed with the outer casing 19 in such a manner that all sides of the metal-air battery cells 40b are enclosed with the outer casing 19 except for front and rear ends thereof in an extension direction of channel structures 15 of channel layers 14. Therefore, according to the illustrated embodiment, oxygen (O₂) may be easily supplied to positive electrode layers 13 even though the number of the metal-air battery cells 40b having the outermost negative electrode metal layers 11 is increased.

FIGS. 17A to 17C are schematic cross-sectional views illustrating a method of fabricating the metal-air battery cell 10 illustrated in FIG. 1.

Referring to FIG. 17A, a negative electrode electrolyte film 12 is disposed on top of a negative electrode metal layer 11. The negative electrode metal layer 11 and the negative electrode electrolyte film 12 may be individually fabricated and may then be attached to each other, or the negative electrode electrolyte film 12 may directly be formed on top of the negative electrode metal layer 11.

The negative electrode metal layer 11 is configured for intercalation/deintercalation of metal ions. In an embodiment, for example, the negative electrode metal layer 11 may be formed from lithium (Li), sodium (Na), zinc (Zn), potassium (K), calcium (Ca), magnesium (Mg), iron (Fe), aluminum (Al), or an alloy thereof.

The negative electrode electrolyte film 12 is configured to deliver metal ions to a positive electrode layer 13. To this end, the negative electrode electrolyte film 12 may include an electrolyte prepared by dissolving a metal salt in a solvent. The electrolyte may be a solid electrolyte including a polymer electrolyte, an inorganic electrolyte, or a combination thereof. The electrolyte may be prepared in such a manner that the electrolyte has flexibility in a process described later. In embodiments, for example, the metal salt may be a lithium salt such as LiN(SO₂CF₂CF₃)₂, LiN(SO₂C₂F₅)₂, LiClO₄, LiBF₄, LiPF₆, LiSbF₆, LiAsF₆, LiCF₃SO₃, LiN(SO₂CF₃)₂, LiC(SO₂CF₃)₃, LiN(SO₃CF₃)₂, LiC₄F₉SO₃, LiAlCl₄ or LiTFSI (Lithium bis(trifluoromethanesulfonyl)imide). In addition to the lithium salt, the metal salt may further include another metal salt such as AlCl₃, MgCl₂, NaCl, KCl, NaBr, KBr, or CaCl₂. The solvent may be any of a number of solvents capable of dissolving the above-listed lithium salts and metal salts.

In addition, the negative electrode electrolyte film 12 may further include a separator impermeable with respect to oxygen (O₂) but permeable with respect to metal ions. The separator may be a flexible polymer separator. In an embodiments, for example, the separator may be a nonwoven polymer fabric such as a nonwoven polypropylene fabric or a nonwoven polyphenylene sulfide fabric, or may be a porous olefin-containing film such as a porous polyethylene film or a porous polypropylene film.

The separator and the electrolyte may form different layers within the negative electrode electrolyte film 12, or the separator (e.g., porous separator) may be impregnated with the electrolyte to form a single layer within the negative electrode electrolyte film 12. In an embodiment of forming the negative electrode electrolyte film 12, for example, pores of a porous separator may be impregnated with an electrolyte prepared by combining polyethylene oxide (“PEO”) and LiTFSI.

Referring to FIG. 17B, the positive electrode layer 13 is formed on top of the negative electrode electrolyte film 12. The positive electrode layer 13 may include an electrolyte for conducting metal ions, a catalyst for oxidation/reduction of oxygen (O₂), a conductive material, and a binder. In an embodiment of forming the positive electrode layer 13, for example, the electrolyte, the catalyst, the conductive material, and the binder may be combined with each other, and a solvent may be added to the combination to form a positive electrode slurry. Thereafter, the positive electrode slurry may be applied to the negative electrode electrolyte film 12 and dried to form the positive electrode layer 13.

The electrolyte of the positive electrode layer 13 may include the above-described lithium salt or metal salt. In embodiments, for example, the conductive material of the positive electrode layer 13 may be a porous material such as a carbon-containing material, a conductive metal material, a conductive organic material, or a combination thereof. In embodiments, for example, the carbon-containing material may be carbon black, graphite, graphene, active carbon, carbon fiber, or carbon nanotubes. In embodiments, for example, the conductive metal material may be metal powder. In embodiments, for example, the catalyst of the positive electrode layer 13 may be platinum (Pt), gold (Au), or silver (Ag). Alternatively, the catalyst may be an oxide of manganese (Mn), nickel (Ni), or cobalt (Co). In embodiments, for example, the binder of the positive electrode layer 13 may be polytetrafluoroethylene (“PTFE”), polypropylene, polyvinylidene fluoride (“PVDF”), polyethylene, or styrene-butadiene rubber (“SBR”).

Referring to FIG. 17C, a channel layer 14 including a plurality of channel structures 15 is disposed on top of the positive electrode layer 13.

The channel layer 14 is formed to cause air incident thereinto to flow on the positive electrode layer 13, and for this purpose, the channel layer 14 may include the channel structures 15 which define the channel layer 14. Each of the channel structures 15 may be elongated to extend in a direction (for example, a y-axis direction) crossing the laminating direction (z-axis direction) of the positive electrode layer 13. The channel structures 15 may be arranged in a direction (x-axis direction) perpendicular to both the laminating direction (z-axis direction) of the positive electrode layer 13 and the extension direction (y-axis direction) of the channel structures 15. In an embodiment, for example, the channel layer 14 may have a corrugated shape defined by alternating ridges and grooves.

Each of the channel structures 15 may be convex in a direction opposite to an upper surface 131 of the positive electrode layer 13. Cavities C are defined by inner surfaces 151 of the convex channel structures 15 and the upper surface 131 of the positive electrode layer 13. The cavities C are elongated to extend in the same direction as the extension direction of the channel structures 15. Ambient air may be introduced into the cavities C through at least one of front and rear ends of each of the cavities C in the extension direction of the cavities C. In addition, ambient air may be introduced into the cavities C through a thickness of the channel layer 14 depending on a material used to form the channel structures 15 of the channel layer 14.

The cavities C may have a semicircular cross-sectional shape. The cavities C are not limited thereto and may have various cross-sectional shapes as long as the cavities C are convex with reference to the upper surface 131 of the positive electrode layer 13. In embodiments, for example, cavities C1, C2 and C3 having a polygonal shape such as a triangular shape or a rectangular shape, or a wave-form shape as shown in FIGS. 3A to 3C may be formed by the channel structures 15.

The channel layer 14 may be formed of any of a number of materials as long as a convex profile and the shape of the channel structures 15 is maintained. In an embodiment, for example, the channel layer 14 may be formed of a porous material including one selected from metals, ceramic materials, polymers, carbon materials, light metals and combinations thereof. Since the channel layer 14 has a porous structure, the channel layer 14 may absorb oxygen (O₂) included in the air and smoothly diffuse the oxygen (O₂) into the cavities C. Examples of the porous metals include foam metals in the form of a sponge, and metal fiber mats. Examples of the porous carbon materials may include carbon paper, carbon cloth, and carbon felt that are formed of carbon fibers. Examples of the porous ceramic materials may include magnesium-aluminum silicate. Examples of the porous polymers may include porous polyethylene and porous polypropylene. Examples of the porous light metals may include nickel meshes, and flexible composite materials made of polymers and nickel meshes.

In a method of fabricating the metal-air battery cell 10 illustrated in FIG. 1, an oxygen blocking layer 16 may be disposed on a lower surface 111 of the negative electrode metal layer 11, such as shown in FIG. 6. Owing to the oxygen blocking layer 16, the negative electrode metal layer 11 may not be exposed to the atmosphere outside the metal-air battery cell 10.

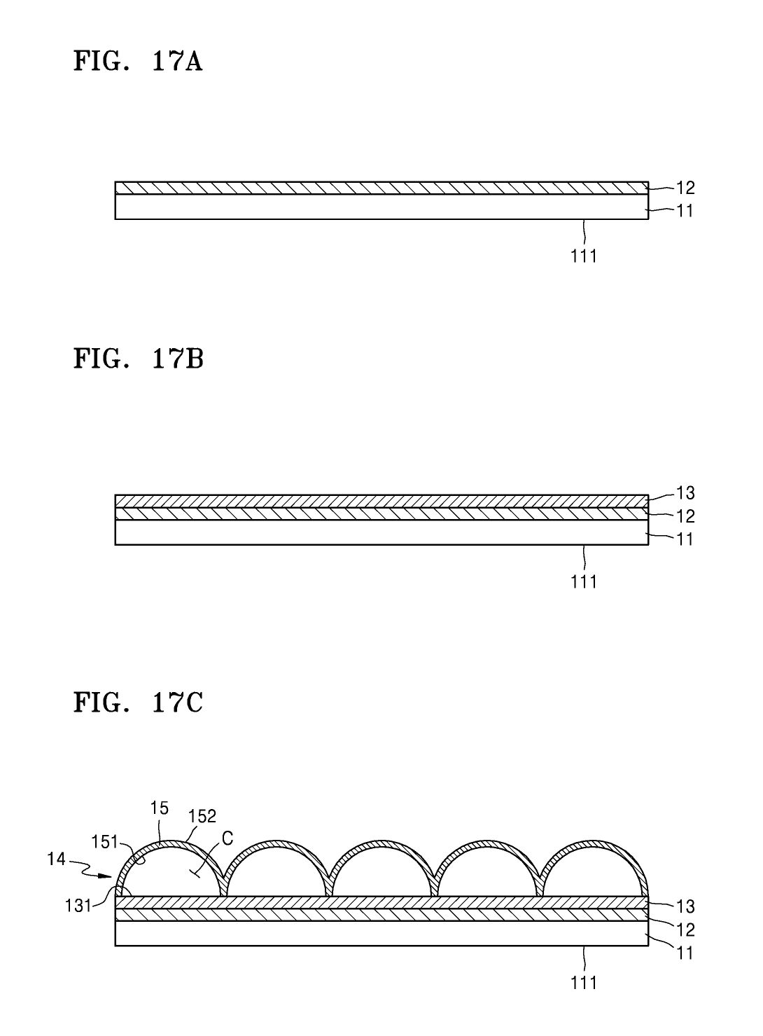

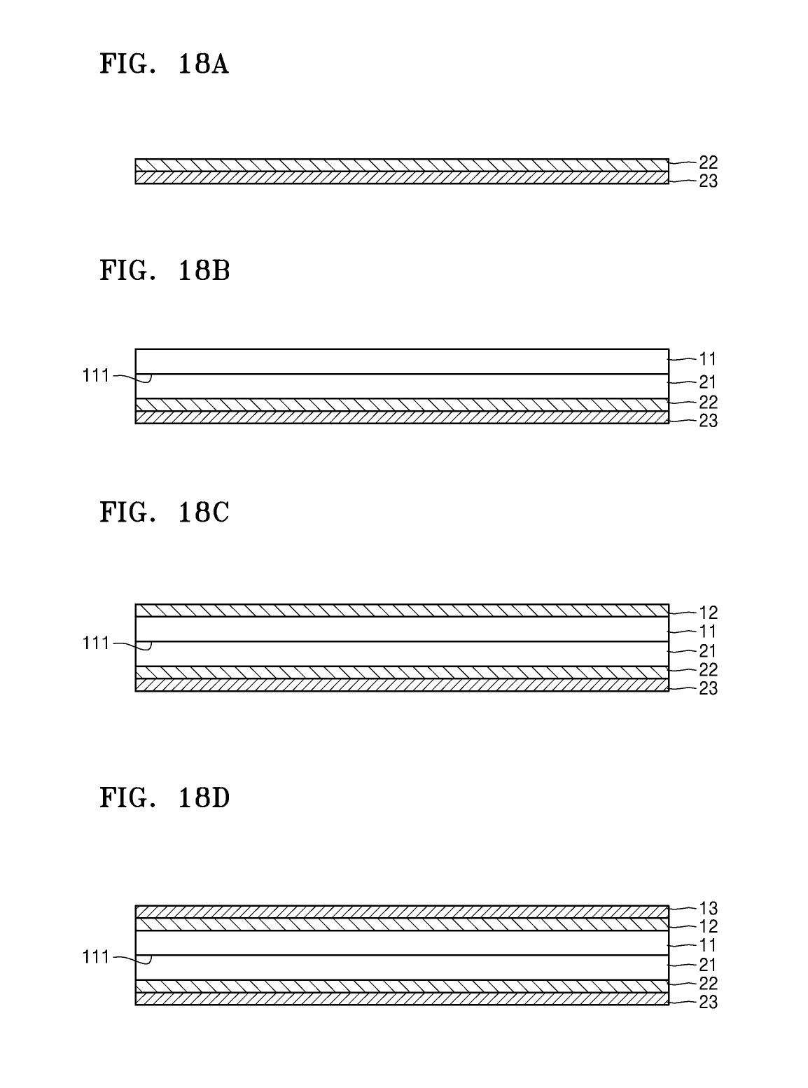

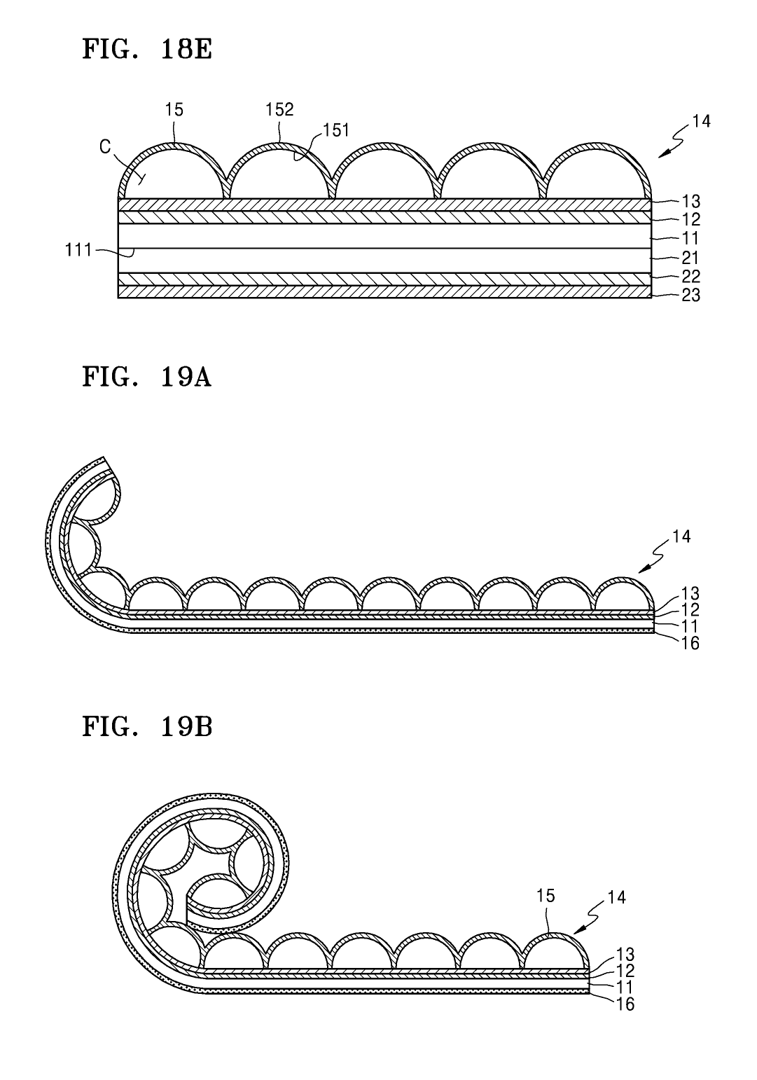

FIGS. 18A to 18E are schematic cross-sectional views illustrating a method of fabricating the metal-air battery cell 20 illustrated in FIG. 5.

Referring to FIG. 18A, a second negative electrode electrolyte film 22 is disposed on top of a second positive electrode layer 23.

The second positive electrode layer 23 may include an electrolyte configured for conducting metal ions, a catalyst for oxidation/reduction of oxygen (O₂), a conductive material, and a binder. In an embodiment of forming the second positive electrode layer 23, for example, the electrolyte, the catalyst, the conductive material, and the binder may be combined with each other, and a solvent may be added to the combination to form a positive electrode slurry. Thereafter, the positive electrode slurry may be applied to the second negative electrode electrolyte film 22 and dried to form the second positive electrode layer 23.

The second negative electrode electrolyte film 22 may include an electrolyte prepared by dissolving a metal salt in a solvent. The electrolyte may be a solid electrolyte including a polymer electrolyte, an inorganic electrolyte, or a combination thereof, and may be prepared in such a manner that the electrolyte has flexibility. In embodiments, for example, the metal salt may be a lithium salt such as LiN(SO₂CF₂CF₃)₂, LiN(SO₂C₂F₅)₂, LiClO₄, LiBF₄, LiPF₆, LiSbF₆, LiAsF₆, LiCF₃SO₃, LiN(SO₂CF₃)₂, LiC(SO₂CF₃)₃, LiN(SO₃CF₃)₂, LiC₄F₉SO₃, LiAlCl₄ or LiTFSI (Lithium bis(trifluoromethanesulfonyl)imide). In addition to the lithium salt, the metal salt may further include another metal salt such as AlCl₃, MgCl₂, NaCl, KCl, NaBr, KBr, or CaCl₂. The solvent may be any of a number of solvents capable of dissolving the above-listed lithium salts and metal salts.

In addition, the second negative electrode electrolyte film 22 may further include a separator impermeable with respect to oxygen (O₂) and conductive with respect to metal ions. The separator may be a flexible polymer separator. In embodiments, for example, the separator may be a nonwoven polymer fabric such as a nonwoven polypropylene fabric or a nonwoven polyphenylene sulfide fabric, or may be a porous olefin-containing film such as a porous polyethylene film or a porous polypropylene film.

The separator and the electrolyte may form different layers in the negative electrode electrolyte film 22, or the separator (e.g., porous separator) may be impregnated with the electrolyte to form a single layer within the negative electrode electrolyte film 22. In an embodiment of forming the second negative electrode electrolyte film 22, for example, the second negative electrode electrolyte film 22 may be formed by impregnating pores of a porous separator with an electrolyte prepared by combining polyethylene oxide (“PEO”) and LiTFSI. In an embodiment, for example, the second negative electrode electrolyte film 22 may be formed of the same material used to form the (first) negative electrode electrolyte film 12.

Referring to FIG. 18B, a second negative electrode metal layer 21 and a (first) negative electrode metal layer 11 are sequentially disposed on top of the second negative electrode electrolyte film 22.

The second negative electrode metal layer 21 and the (first) negative electrode metal layer 11 are formed for intercalation/deintercalation of metal ions. In embodiments, for example, the second negative electrode metal layer 21 and the (first) negative electrode metal layer 11 may be formed from lithium (Li), sodium (Na), zinc (Zn), potassium (K), calcium (Ca), magnesium (Mg), iron (Fe), aluminum (Al), or an alloy thereof. The second negative electrode metal layer 21 and the (first) negative electrode metal layer 11 may form different distinct layers within the metal-air battery cell 20. However, the invention is not limited thereto. In an alternative embodiment, for example, the second negative electrode metal layer 21 and the negative electrode metal layer 11 may collectively form a single layer (e.g., monolayer) among layers of the metal-air battery cell 20.

As shown in FIGS. 18C to 18E, a (first) negative electrode electrolyte film 12, a (first) positive electrode layer 13, and a channel layer 14 may be sequentially disposed on top of the (first) negative electrode metal layer 11. This is similar to the description with reference to FIGS. 17A to 17C, and thus a description thereof will not be repeated.

After the metal-air battery cells 10 and 20 are fabricated by performing the processes described with reference to FIGS. 17A to 17C and 18A to 18E, the metal-air battery cells 10 and 20 may be deformed through an additional process.

FIGS. 19A and 19B are schematic cross-sectional views illustrating an exemplary process of deforming the metal-air battery cell 10 illustrated in FIG. 17C. With reference to FIGS. 19A and 19B, a description will now be given of how the negative electrode metal layer 11, the negative electrode electrolyte film 12, the positive electrode layer 13 and the channel layer 14 are rolled to dispose the negative electrode metal layer 11 on top of the channel layer 14.

The negative electrode metal layer 11, the negative electrode electrolyte film 12, the positive electrode layer 13 and the channel layer 14 of the formed metal-air battery cell 10 are bent together so that portions of the channel layer 14 may make contact with each other, as illustrated at the left of FIG. 19A. With the portions of the channel layer 14 in contact with each other, the negative electrode metal layer 11, the negative electrode electrolyte film 12, the positive electrode layer 13 and the channel layer 14 are further bent so that the channel layer 14 and the negative electrode metal layer 11 may make contact with each other, as illustrated at the left of FIG. 19B. Further bending of the negative electrode metal layer 11, the negative electrode electrolyte film 12, the positive electrode layer 13 and the channel layer 14 may dispose the channel layer 14 and the negative electrode metal layer 11 in direct contact with each other. If the oxygen blocking layer 16 is disposed at the lower surface 111 of the negative electrode metal layer 11, further bending of the negative electrode metal layer 11, the negative electrode electrolyte film 12, the positive electrode layer 13 and the channel layer 14 may dispose the channel layer 14 and the negative electrode metal layer 11 in indirect contact with each other with the oxygen blocking layer 16 being disposed therebetween.

In this way, the metal-air battery cell 10 is continuously rolled to bring the channel layer 14 and the negative electrode metal layer 11 into contact with each other at multiple locations. Then, by the continuous rolling of the metal-air battery cell 10, the metal-air battery cell 30b of FIGS. 7B_1 and 7B_2 having a roll shape may be fabricated. However, the rolling direction of the metal-air battery cell 30b may be varied. In an alternative embodiment, for example, the negative electrode metal layer 11, the negative electrode electrolyte film 12, the positive electrode layer 13 and the channel layer 14 may be rolled in a direction in which portions of the negative electrode metal layer 11 are first brought into contact with each other and then continuously rolled, so as to form the metal-air battery cell 30a shown in FIGS. 7A_1 and 7A_2.

The above-described process illustrated in FIGS. 19A and 19B of deforming the shape of the metal-air battery cell 10 may be applied to the second metal-air battery cell 20 illustrated in FIG. 18E.

In the embodiments of FIGS. 2, 4, 5 and 6, the channel layer 14 is formed to be disposed on the entirety of the positive electrode layer 13. However, the invention is not limited thereto. In alternative embodiments, for example, as shown in FIGS. 9 to 11A, a channel layer 14 may be formed on top of a portion of a single continuous positive electrode layer 13 to expose a remaining portion of the positive electrode layer 13. Then, each of a negative electrode metal layer 11, a negative electrode electrolyte film 12 and the positive electrode layer 13 which is continuous extended may be bent to cover at least three sides of the channel layer 14, so as to form a metal-air battery cell 40a, 40b or 40c.

As described above, in one or more embodiment of a metal-air battery cell of the present invention, the channel layer including a plurality of channel structures extending in a direction crossing the laminating direction of the positive electrode layer is disposed on top of the positive electrode layer. Therefore, oxygen (O₂) may smoothly contact the positive electrode layer, and an increase in the thickness of the metal-air battery cell may be minimized. Accordingly, more metal-air battery cells may be disposed in a given planar area, and thus a metal-air battery having a high energy density may be provided.

The metal-air battery cells 10, 10a, 10b, 20, 30a, 30b, 30c, 30d, 40a, 40b and 40c, the metal-air batteries 1, 2, 3, 4a and 4b, and the methods of manufacturing the same have been described according to embodiments of the present invention with reference to the accompanying drawings. However, it should be understood that the embodiments described herein should be considered in a descriptive sense only and not for purposes of limitation. Descriptions of features or elements within each embodiment should typically be considered as available for other similar features or elements in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A metal-air battery cell comprising:
a first negative electrode metal layer;
a first positive electrode layer configured to use oxygen as an active material for which a reduction/oxidation reaction of oxygen introduced thereto occurs;
a first negative electrode electrolyte film disposed between the first negative electrode metal layer and the first positive electrode layer in a thickness direction; and
a first channel layer disposed on the first positive electrode layer and comprising a plurality of first channel structures, the first channel structures each elongated to extend in an extension direction crossing the thickness direction.

2. The metal-air battery cell of claim 1, wherein each first channel structure among the plurality of first channel structures is convex in a direction away from an upper surface of the first positive electrode layer.

3. The metal-air battery cell of claim 2, wherein first cavities of the first channel layer are defined by the upper surface of the first positive electrode layer and inner surfaces of the convex first channel structures, respectively.

4. The metal-air battery cell of claim 3, wherein the first cavities of the first channel layer have a polygonal cross-sectional shape, a semicircular cross-sectional shape or a wave-form cross-sectional shape.

5. The metal-air battery cell of claim 1, further comprising:
a second negative electrode metal layer disposed under the first negative electrode metal layer;
a second positive electrode layer disposed under the second negative electrode metal layer and configured to use oxygen as an active material for which a reduction/oxidation reaction of oxygen introduced thereto occurs; and
a second negative electrode electrolyte film disposed between the second negative electrode metal layer and the second positive electrode layer in the thickness direction.

6. The metal-air battery cell of claim 1, wherein the first negative electrode metal layer, the first negative electrode electrolyte film and the first positive electrode layer are each continuously extended and disposed at opposing sides of the first channel layer in the thickness direction.

7. The metal-air battery cell of claim 1, wherein the first negative electrode metal layer, the first negative electrode electrolyte film, the first positive electrode layer and the first channel layer are each continuously extended and bent about an axis to define the metal-air battery cell in a roll form.

8. The metal-air battery cell of claim 1, wherein
the first negative electrode metal layer, the first negative electrode electrolyte film and the first positive electrode layer are each continuously extended and bent upward toward the first channel layer to define the metal-air battery cell in a flat form, and
in the flat form of the metal-air battery cell, the first positive electrode layer contacts apexes of the convex first channel structures of the first channel layer.

9. The metal-air battery cell of claim 1, wherein an end of the first channel layer in the extension direction of the first channel structures is exposed outside the metal-air battery cell.

10. The metal-air battery cell of claim 1, further comprising:
a sub positive electrode layer configured to use oxygen as an active material for which a reduction/oxidation reaction of oxygen introduced thereto occurs, disposed on a surface of the first channel structures of the first channel layer.

11. The metal-air battery cell of claim 1, wherein the first negative electrode electrolyte film comprises:
a separator which is impermeable with respect to oxygen and conductive with respect to metal ions; and
an electrolyte configured to conduct the metal ions.

12. The metal-air battery cell of claim 1, wherein the first channel structures of the first channel layer have a porous structure.

13. A metal-air battery comprising:
a first metal-air battery cell and a second metal-air battery cell,
wherein each of the first and second metal-air battery cells comprises:
a first negative electrode metal layer;
a first positive electrode layer configured to use oxygen as an active material for which a reduction/oxidation reaction of oxygen introduced thereto occurs;
a first negative electrode electrolyte film disposed between the first negative electrode metal layer and the first positive electrode layer in a thickness direction; and
a first channel layer disposed on the first positive electrode layer and comprising a plurality of first channel structures, the first channel structures each elongated to extend in an extension direction crossing the thickness direction.

14. The metal-air battery of claim 13, wherein the first channel layer of the first metal-air battery cell is disposed between the first negative electrode metal layers of the first and second metal-air battery cells in the thickness direction.

15. The metal-air battery of claim 14, further comprising an oxygen blocking layer disposed between the first channel layer of the first metal-air battery cell and the first negative electrode metal layer of the second metal-air battery cell in the thickness direction.

16. The metal-air battery of claim 13, wherein each of the first and second metal-air battery cells further comprises:
a second negative electrode metal layer disposed under the first negative electrode metal layer;
a second positive electrode layer disposed under the second negative electrode metal layer and configured to use oxygen as an active material for which a reduction/oxidation reaction of oxygen introduced thereto occurs; and
a second negative electrode electrolyte film disposed between the second negative electrode metal layer and the second positive electrode layer in the thickness direction.

17. The metal-air battery of claim 13, wherein for each of the first and second metal-air battery cells,
the first negative electrode metal layer, the first negative electrode electrolyte film and the first positive electrode layer are each continuously extended and disposed at opposing sides of the first channel layer in the thickness direction.

18. A method of fabricating a metal-air battery cell, the method comprising:
disposing a first negative electrode electrolyte film between a first negative electrode metal layer and a first positive electrode layer in a thickness direction, the first positive electrode layer configured to use oxygen as an active material for which a reduction/oxidation reaction of oxygen introduced thereto occurs; and
disposing a first channel layer on the first positive electrode layer, the first channel layer comprising a plurality of first channel structures each elongated to extend in an extension direction crossing the thickness direction.

19. The method of claim 18, further comprising:
disposing a second negative electrode electrolyte film between a second negative electrode metal layer and a second positive electrode layer, the second positive electrode layer configured to use oxygen as an active material for which a reduction/oxidation reaction of oxygen introduced thereto occurs; and
disposing the second negative electrode metal layer and the first negative electrode metal layer facing each other.

20. The method of claim 18, wherein the first negative electrode metal layer, the first negative electrode electrolyte film and the first positive electrode layer are each continuously extended,
further comprising bending the continuously extended first negative electrode metal layer, first negative electrode electrolyte film and first positive electrode layer to be disposed at opposing sides of the first channel layer in the thickness direction.
